(19) United States
(12) Patent Application Publication
(10) Pub. No.: US 2005/0138225 A1
(43) Pub. Date: Jun. 23, 2005

(54) Integrated device

(76) Inventor: Tsai-Sheng Chiu, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/802,450

(22) Filed: Mar. 17, 2004

(30) Foreign Application Priority Data
Dec. 17, 2003 (TW) 92222079

(51) Int. Cl. G06F 3/00

(52) U.S. Cl. 710/2

(57) ABSTRACT

A universal serial bus integrated device. The integrated device comprises a housing and an integrated circuit board. The integrated circuit board is disposed in the housing, comprising a plurality of universal serial bus slots thereon.

### BACKGROUND OF THE INVENTION

1. Field of the Invention

The present invention relates to an integrated device, and in particular to a universal serial bus (USB) integrated device for enlarging the capacity of peripheral devices therein.

2. Description of the Related Art

Personal and industrial computers usually require various peripheral devices. A conventional computer comprises not only a central processing device, but also other peripheral devices such as RAM, video card, sound card, hard disk drives, CD-ROM drives, floppy disk drives, each of which is connected to a motherboard via cable connectors or slot connectors of different interfaces such as IDE (integrated device electronics), PCI (peripheral component interconnect), and AGP (accelerated graphics port) slots, disposed either inside or outside the housing. Currently, the most widely used interface is the universal serial bus (USB) interface, which possesses relatively faster data transfer between a processor and peripheral devices. As shown in FIG. 1, a conventional computer 1 comprises at least two USB ports 2 in addition to traditional serial, parallel, and keyboard/mouse ports (not shown). A USB cable 3 has two ends, respectively having a different-shaped USB connector 31 or 32 for preventing improper connections between the USB ports 2 and the peripheral devices (USB interface devices) 4. The USB interface typically provides a much faster transfer rate of 1.5 Mbps to 12 Mbps, than the speeds provided by a parallel or serial port. Thus, data transfer efficiency between the computer 1 and peripheral devices 4 is greatly improved via the USB cable 3. Additionally, operating system such as Microsoft Windows 2000 or Windows XP supports the USB interface. Thus, computer 1 can be equipped with USB interface devices 4 such as USB network interface cards, hubs, keyboards, mouse, joysticks, CD-ROM drives, disk drives, printers, scanners, and digital cameras. A major advantage of USB is the ability to “hot swap” peripheral devices, that is, the host computer needs not to be turned off when a new device is connected thereto.

As mentioned above, in the conventional computer, most peripheral devices are typically connected by cables or slot connectors with different interfaces. Cables, however, may become tangled in the limited space provided inside the computer housing. To increase the available space in the PC, some peripheral devices can be externally connected thereto via USB ports. This, however, brings the same problem of tangled and disorganized cables, outside the PC. The limited number of USB ports on each motherboard limits the numbers of peripheral devices that can be connected to the PC.

Hence, it is desirable to provide an integrated device capable of integrating different interfaces, thereby minimizing the number of external cables and tangling thereof.

### SUMMARY OF THE INVENTION

Accordingly, an object of the present invention is to provide a USB integrated device, capable of integrating different peripheral devices in a housing with a compact profile, thereby minimizing the problems of disorganized cables.

Another object of the invention is to provide a USB integrated device comprising an integrated circuit board with a plurality of USB interface slots thereon, thereby expanding peripheral connectivity.

Another object of the invention is to provide a USB integrated device wherein any peripheral device is “hot swappable”, that is, devices can be added to or removed from the host without turning off the power.

The present invention provides a USB integrated device comprising a housing and an integrated circuit board. The integrated circuit board with a plurality of USB interface slots thereon is disposed in the housing.

The USB integrated device has a first peripheral device, detachably connected to one of the USB slots.

The first peripheral device comprises a converter and a first USB connector. The first USB connector is inserted into the USB slot. The signal of the first peripheral device is converted to USB interface signal by the converter.

The USB integrated device further comprises a central processing device, detachably connected to one of the USB slots.

The central processing device also comprises a converter and a first USB connector. The first USB connector is inserted into the USB slot. The signal of the first peripheral device is converted to USB interface signal by the converter.

### BRIEF DESCRIPTION OF THE DRAWINGS

FIG. 1 (prior art) is a schematic diagram of a computer with peripheral devices connected thereto;

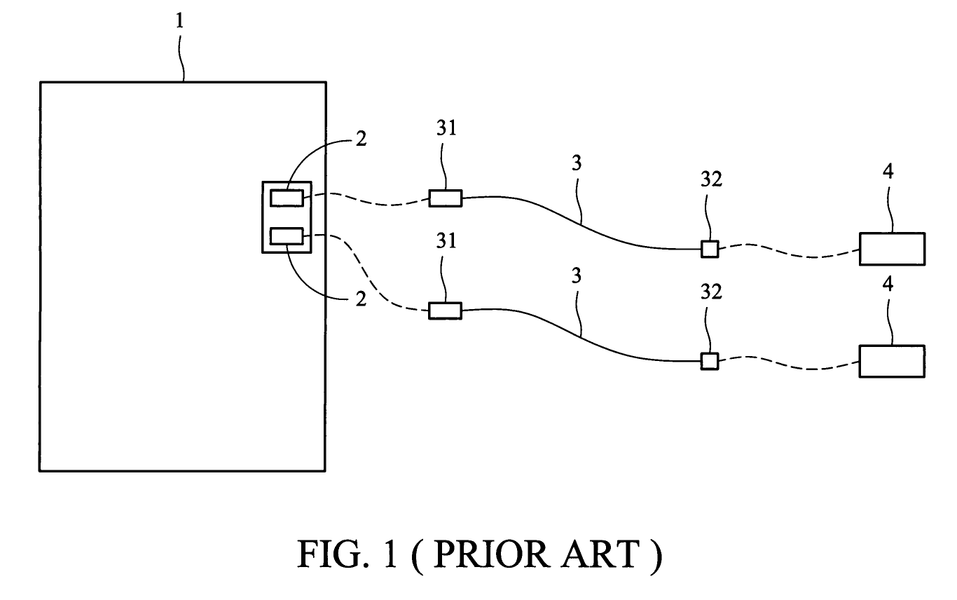

FIG. 2 is a schematic cross section of a USB integrated device according to the present invention;

FIG. 3 is a front view of an integrated circuit board according to the present invention;

FIG. 4 is a rear view of the integrated circuit board according to the present invention;

FIG. 5 is a schematic diagram showing a peripheral device disposed in the USB integrated device according to the present invention.

### DETAILED DESCRIPTION OF THE INVENTION

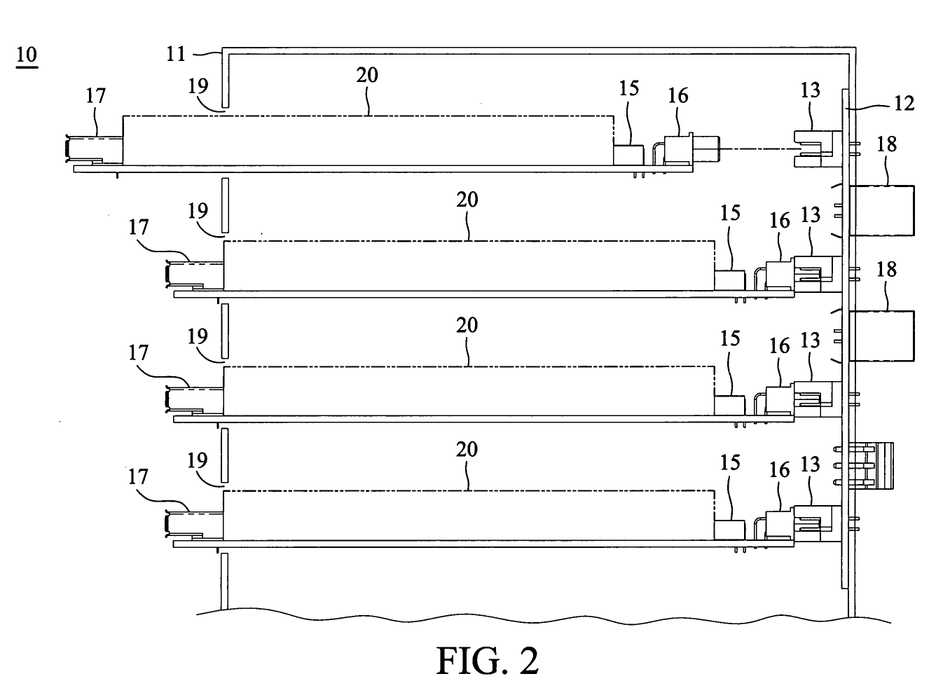

FIG. 2 is a schematic cross section of a USB integrated device according to the present invention. The USB integrated device of the invention, based essentially on the USB interface, comprises an integrated circuit board 12 for connecting various peripheral devices. Although the USB integrated device of the present invention modifies the connections between the motherboard and peripheral devices, the present invention still preserves features of conventional personal and industrial computers.

As shown in FIG. 2, the USB integrated device 10 comprises a housing 11, an integrated circuit board 12 (also called a backplane), and a first peripheral device 20.

The interconnection for the housing 11, the integrated circuit board 12, and the first peripheral device 20 is described as follows.

The housing 11 is a hollow rectangular structure. The integrated circuit board 12 and the first peripheral device 20 are both disposed therein. The integrated circuit board 12 includes a plurality of USB slots 13, respectively disposed thereon. In one embodiment, the first peripheral device 20 is shaped into a plate. When a central processing device is disposed in the housing 11, the housing 11 with the central processing device acts as an ordinary computer. The first peripheral device 20 can be a RAM, a modem, a video card, a sound card, a hard disk, a CD-ROM drive, or a floppy disk drive. The present invention does not limit the size and shape of the housing 11 and peripheral devices. Any size or shape of peripheral device 20 can be inserted into the USB slots 13 of the integrated circuit board 12.

The front side of the integrated circuit board 12 is the side facing the first peripheral device 20. The USB slots 13 or expansion slots are disposed on the front side of the integrated circuit board 12. In this figure, only four USB slots 13 and the corresponding first peripheral devices 20 are shown. The top-most first peripheral device 20 in this figure is detached from the USB slot 13. The other three first peripheral devices 20 are connected to the USB slots 13. Each first peripheral device 20 includes a converter 15, a first USB connector 16, and a USB port 17. Furthermore, the rear side of the integrated circuit board 12 has a plurality of second connectors 19 disposed thereon, for connecting other types of devices such as external peripheral devices.

In addition, the housing 11 further has at least one opening 19. When there is only one opening 19, each first peripheral device 20 can be inserted or removed via the opening 19. When the housing 11 has a plurality of openings 19, each formed on one side of the housing 11 corresponding to each first peripheral device 20, the size and shape of the openings 19 also correspond to those of the first peripheral device 20. Since the USB interface provides a “hot swapping” feature, i.e., the computer needs not to be turned off when adding or removing a peripheral device, users may easily attach to or detach from a first peripheral device 20 through a corresponding opening 19 of the housing 11. Thus, the present invention facilitates “hot swapping” of any peripheral device regardless of the interface type.

The following illustrates benefits of connections between the integrated circuit board 12 and the first peripheral device 20.

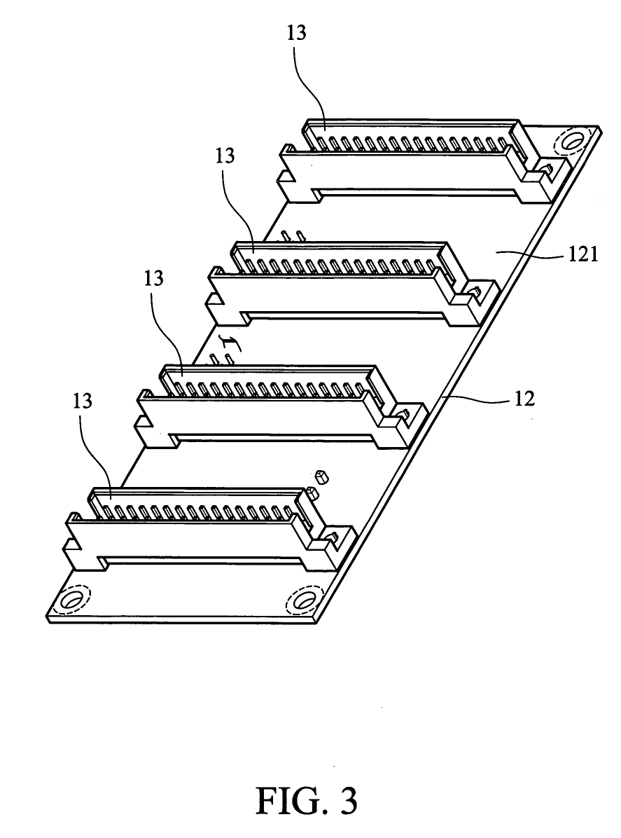

As shown in FIG. 3, the front side of the integrated circuit board 12 is facing the first peripheral device 20 with a plurality of USB slots 13 provided on the front side. The invention can convert signals of the peripheral device 20 to USB signals by inserting the device 20 into the USB slots 13 of the integrated circuit board 12 without using any other type of interface slot. Thus, different types of peripheral devices can be disposed in the housing 11, providing a compact profile and eliminating excess cables connected to the computer and further solving the problem of tangled cables.

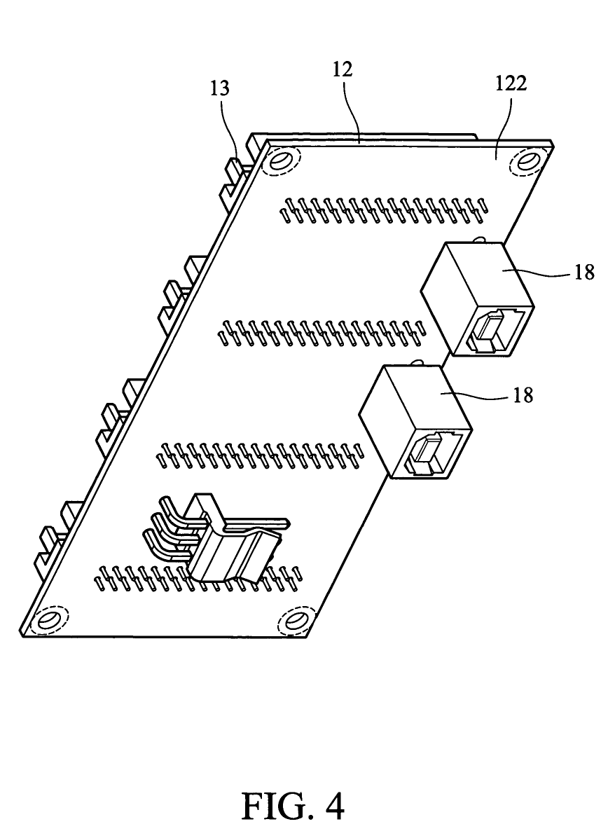

FIG. 4 is a rear view of the integrated circuit board 12 according to the present invention. The rear side of the integrated circuit board 12 has a plurality of second USB connectors 18, exposed through the housing 11. The second USB connector 18 can be used to connect to other computers as described in the following.

In another embodiment, when the housing 11 does not include a central processing device, but peripheral devices 20, the housing 11 with a plurality of peripheral devices 20 can be integrated into one peripheral device through the integrated circuit board 12 such that the entire device acts as an integrated adaptor. Although not shown in the figure, the housing 11 becomes an integrated device with the first peripheral devices 20, and the integrated device 11 can be connected to another host computer by a USB cable via the second USB connector 18. Thus, different peripheral devices are integrated into a single integrated device, eliminating the problem of tangled wires.

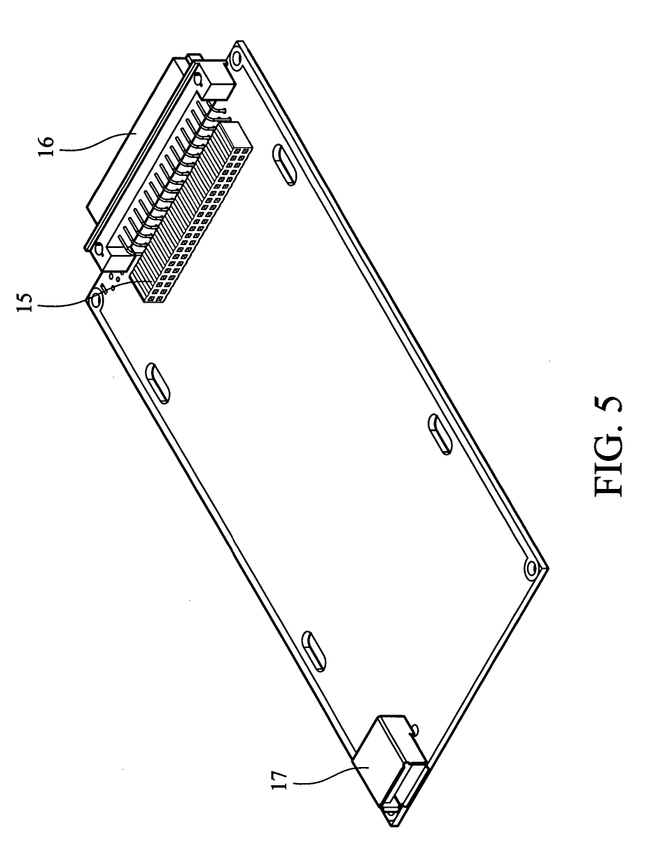

As shown in FIG. 5, the first peripheral device 20 comprises a converter 15 and a first USB connector 16. The first USB connector 16 is inserted into the USB slot 13 of the integrated circuit board 12. Thus, as mentioned above, the signals of the peripheral device 20 can be converted to USB signals. For example, when the first peripheral device 20 is a hard disk drive, the converter 15 converts IDE interface signals to USB signals.

The converter 15 of the present invention is not limited to converting IDE to USB. The main function of the converter 15 is to convert any type of interface to USB interface. Additionally, in other embodiments, when a plate-shaped central processing device is inserted into the USB slot 13, as mentioned above, the housing 11 becomes an independent or a host computer, capable of connecting to other peripheral devices. Thus, the present invention eliminates the use of wires between the computer and the peripheral devices.

Moreover, the first peripheral device 20 further has USB ports 17 provided thereon. The USB ports 17 are exposed through the housing 11. The number of USB ports 17 is up to the available signals designated by the USB slots 13 on the integrated circuit board 12. Consequently, the second peripheral device (not shown) such as a hub, a keyboard, a mouse, a printer, a scanner, a digital camera or other peripherals can be connected to the housing 11 via the unoccupied USB ports 17. Thus, the USB integrated device 10 of the invention is capable not only of connecting a variety of peripheral devices, but also expand external USB connectivity.

In conclusion, the USB integrated device 10 improves peripheral expandibility via the USB slots 13 of the integrated circuit board 12, further eliminating the problems of tangled wires. Moreover, each peripheral device is “hot swappable”.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A universal serial bus integrated device, comprising:
a housing; and
an integrated circuit board, disposed in the housing, comprising a plurality of universal serial bus slots thereon.

2. The integrated device as claimed in claim 1, further comprising a first peripheral device, detachably connected to one of the universal serial bus slots.

3. The integrated device as claimed in claim 2, wherein the first peripheral device comprises a converter and a first universal serial bus connector, inserted into one of the universal serial bus slots, such that signals of the first peripheral device are converted to universal serial bus signals by the converter.

4. The integrated device as claimed in claim 2, wherein the first peripheral device is shaped into a plate.

5. The integrated device as claimed in claim 4, wherein the first peripheral device comprises a hard disk drive.

6. The integrated device as claimed in claim 4, wherein the first peripheral device comprises an optical disk drive.

7. The integrated device as claimed in claim 4, wherein the first peripheral device comprises a modem.

8. The integrated device as claimed in claim 4, wherein the first peripheral device comprises a floppy disk drive.

9. The integrated device as claimed in claim 1, further comprising a central processing device, detachably connected to one of the universal serial bus slots.

10. The integrated device as claimed in claim 9, wherein the central processing device comprises a converter and a first universal serial bus connector, inserted into one of the universal serial bus slots, such that signals of the central processing device are converted to universal serial bus signals by the converter.

11. The integrated device as claimed in claim 1, further comprising a universal serial bus port disposed in the housing and a second peripheral device, connected to the integrated circuit board through the universal serial bus port.

12. The integrated device as claimed in claim 11, wherein the second peripheral device comprises a hub, a keyboard, a mouse, a printer, a scanner, and a digital camera.

13. The integrated device as claimed in claim 1, wherein the integrated circuit board further comprises a second universal serial bus connector for connection with other computers.

14. The integrated device as claimed in claim 1, further comprising an opening, corresponding to the integrated circuit board in the housing.
